(19) United States
(12) Patent Application Publication
(10) Pub. No.: US 2009/0272576 A1
(43) Pub. Date: Nov. 5, 2009

(54) Vehicle High Power Cable Fastening System and Method

(75) Inventor: Alfonso O. Medina, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: ISE CORPORATION, Poway, CA (US)

(21) Appl. No.: 12/112,788

(22) Filed: Apr. 30, 2008

(51) Int. Cl. H02G 3/04

(52) U.S. Cl. 174/72 A; 903/951

(57) ABSTRACT

A cable fastening system for high power cables that operates within a heavy duty vehicle is described. The cable fastening system comprises at least three conductive high-power cables and a cable spacer. The high-power cables include a cable cross-sectional center, and a cross-sectional diameter that is similar for each cable. The cable spacer includes three fixed arms and three arcuate edges. The three fixed arms are disposed at equidistant angles from one another. The three arcuate edges are disposed at equidistant angles from one another and each of the arcuate edges is configured to interface with one of the conductive high-power cables. The cable cross-sectional centers and oriented in a triangular formation and the cable spacer is configured to separate the cables so that the distance between two adjacent cable cross-sectional centers is less than one times the cross-sectional diameter.

### FIELD OF THE INVENTION

The present invention relates to a hybrid electric vehicle high power cable fastening system. More particularly, the invention relates to a cable fastening system having a cable spacer that separates and positions vehicle high power cables.

### BACKGROUND

In a vehicle having an electric drive system, such as an electric vehicle, “hybrid” electric vehicle, etc., high power cables supply power from a power supply such as a generator or a battery to an electric motor for propulsion of the vehicle. High power cables also transfer power between other components such as energy storage packs and energy dissipation devices. Similarly, high power cables are commonly used in hybrid drive systems for heavy-duty vehicles. Routing clamps route the high power cables through an electrical vehicle. These routing clamps suffer from a number of drawbacks, which will be described in more detail further below.

### SUMMARY

A cable fastening system and method for high power cables that operate within a heavy duty vehicle is described. The cable fastening system is an efficient clamping system that manages high power cables in a hybrid/electric drive system, while mitigating problems associated with chaffing, constricted airflow, RF noise, and the mobile environment. Moreover, the cable fastening system makes use of the electric properties of the high power cables.

The cable fastening system comprises at least three conductive high-power cables and a cable spacer. The high-power cables include a cable cross-sectional center, and a cross-sectional diameter that is similar for each cable. The cable spacer is configured to separate the three conductive high power cables. The cable spacer includes three fixed arms and three arcuate edges. The three fixed arms are disposed at equidistant angles from one another. The three arcuate edges are disposed at equidistant angles from one another and each of the arcuate edges is configured to interface with one of the conductive high-power cables. In the illustrative embodiment, each fixed arm separates two arcuate edges and the separated cable cross-sectional centers are equidistant from one another. The cable cross-sectional centers are oriented in a triangular formation. The cable spacer is configured to separate the cables so that the distance between two adjacent cable cross-sectional centers is less than one times the cross-sectional diameter.

Additionally, a cable fastening system for high power cables comprising the cable spacer and a means for coupling the three conductive high-power cables to the cable spacer is described. The means for coupling the three conductive high-power cables to the cable spacer enables each high power cable to interface with the corresponding cable spacer arcuate edge. The three conductive high-power cables are separated from one another by the cable spacer arms and the cable cross-sectional centers for the three conductive high-power cables are equidistant from one another.

### DRAWINGS

The present invention will be more fully understood by reference to the following drawings which are for illustrative, not limiting, purposes.

FIG. 1 shows an illustrative hybrid electric vehicle (HEV) drive system.

FIG. 2 shows an illustrative cable construction for a high power cable.

FIG. 3A shows an isometric view of a routing clamp composed of a top element and a bottom element that are configured to receive two power cables.

FIG. 3B shows a side view of a clamping system that includes stackable clamps.

FIG. 4A shows an isometric view of an embodiment of an illustrative cable spacer.

FIG. 4B shows the cable spacer of FIG. 4A interfacing with power cables and a protective conduit.

FIG. 5 shows another embodiment of a cable fastening system comprising a spacer, outer shells and fasteners.

FIG. 6A shows an isometric view of another embodiment of an illustrative spacer with an exterior interlocking mechanism.

FIG. 6B shows the spacer of FIG. 6A interfacing with two similar spacers using the exterior interlocking mechanism.

FIG. 6C shows an isometric view of the spacer of FIG. 6A anchored to a plate.

FIG. 6D shows a view of the anchoring plate in FIG. 6E without the spacer.

FIG. 7A shows yet another embodiment of a spacer that forms a lattice structure.

FIG. 7B shows three of the spacers in FIG. 7A coupled to one another.

FIG. 7C shows a lattice structure formed from a plurality of spacers.

### DETAILED DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the vehicle high power cable clamping system described hereinafter may vary as to configuration and as to details. Additionally, the methods may vary as to details, order of the actions, or other variations without departing from the illustrative method disclosed herein.

The systems, apparatus and methods described herein provide a means for clamping and separating high voltage cables in a mobile environment efficiently and while reducing electronic noise. The cable fastening systems and cable spacer are configured to be fixedly coupled to high power cables that operate within a heavy duty vehicle such as a hybrid electric vehicle (HEV). The legal definition of a “heavy-duty vehicle” is a vehicle over 8,500 lbs, however, it is common for heavy duty vehicles such as metropolitan transit buses, 18-wheel tractor trailers, and city refuse trucks to be well in excess of 10,000 lbs. A hybrid electric vehicle (HEV) is a vehicle which combines a conventional propulsion system with an on-board rechargeable energy storage system to achieve better fuel economy and cleaner emissions than a conventional vehicle. Although, the cable fastening systems and cable spacer described herein are applied to the power cables for a HEV vehicle, the reference to the HEV vehicle herein is not intended to be limiting as to the disclosure and is provided for illustrative purposes only.

By way of example and not of limitation, the high power cables described herein may be used to carry three-phase electric power in heavy duty vehicles such as HEV commercial vehicles such as metropolitan transit buses, refuse collection vehicles, over-the-road semi trucks, as well as in military and off-road vehicles. Although, the cable fastening systems and cable spacers described herein are applied to the power cables for a HEV vehicle, the reference to the HEV vehicle is not intended to be limiting and is provided for illustrative purposes only. Additionally, it shall be appreciated that the high power cables may be configured to communicate Direct Current (DC) and Alternating Current (AC).

Before describing embodiments of the cable fastening systems and cable spacer of the present invention, an embodiment of a HEV drive system of a heavy-duty vehicle that may be used in and/or with the embodiments of the cable fastening systems and cable spacer of the present invention will first be described.

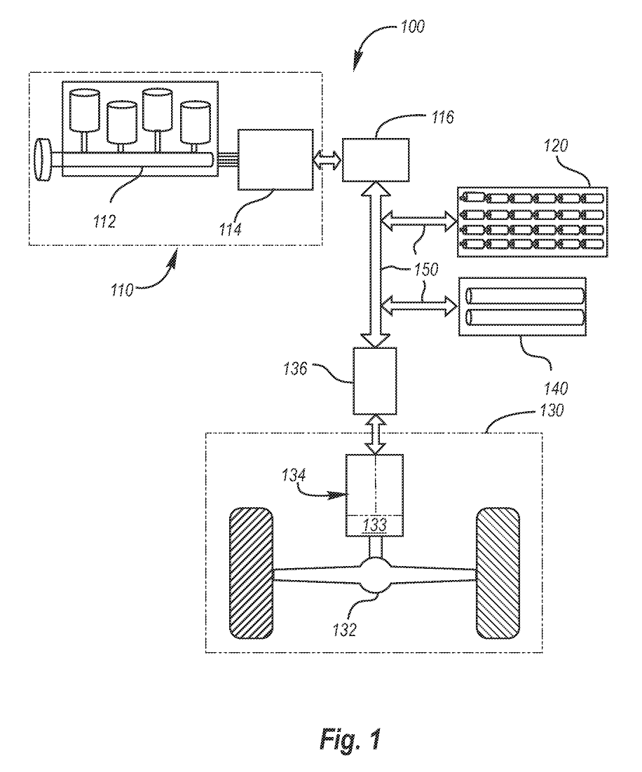

Referring to FIG. 1 there is shown an illustrative HEV drive system. The illustrative HEV drive system 100 uses an energy source such as an “engine genset” 110 comprising an engine 112 (e.g., internal combustion engine (ICE), compressed natural gas (CNG), etc.) coupled to a generator 114, and an energy storage pack 120 (e.g., battery, ultracapacitor, flywheel, etc.) to provide electric propulsion power to its drive wheel propulsion assembly 130. In particular, the engine 112 (here illustrated as an ICE) will drive generator 114, which will generate electricity to power one or more electric propulsion motor(s) 134 and/or charge the energy storage 120. Also, in the alternate the energy source may include a fuel cell. Energy storage 120 may solely power the one or more electric propulsion motor(s) 132 or may augment power provided by the engine genset. Multiple electric propulsion motor(s) 134 may be mechanically coupled via a combining gearbox 133 to provide increased aggregate torque to the drive wheel assembly 132 or increased reliability. Propulsion motor(s) 134 for heavy duty vehicles (i.e., having a gross weight of over 10,000 lbs) may, for example, include two AC induction motors that produce 85 kW of power (×2) and having a rated DC voltage of 650 VDC.

As an added feature to HEV efficiency, rather than dissipating kinetic energy via friction braking, many HEVs recapture the kinetic energy of the vehicle. In particular, kinetic energy is recaptured via regenerative braking. Regenerative braking (“regen”) is where the electric propulsion motor(s) 134 are switched to operate as generators, and a reverse torque is applied to the drive wheel assembly 132. This torque results in a net braking force on the vehicle. As the vehicle transfers its kinetic energy to the electric propulsion motor(s) 134, now operating as a generator(s), electricity is generated, and the vehicle slows. The electricity generated is then stored in the energy storage 120 to be used later in the drive cycle. Regenerative braking may also be incorporated into an all-electric vehicle (EV) thereby providing a way to recuperate energy from the driving cycle.

Since the ICE's 112 primary function is simply to drive the electric generator 114, the ICE 112 may be optimized for limited range of operation and can run more efficiently than a conventional ICE, which must be designed to provide drive power over various speed and loading profiles. Additionally, by recapturing its own kinetic energy, the demand on the ICE 112 to generate energy is reduced, thus making the HEV drive system 100 even more efficient.

When the energy storage 120 reaches a predetermined capacity (e.g., fully charged), the HEV drive system 100 may then dissipate any additional regenerated electricity through a resistive braking resistor 140. Typically, the braking resistor 140 will be included in the cooling loop of the ICE 112, and will dissipate excess energy as heat.

Unlike lower rated systems, heavy duty high power HEV drive system components may also generate substantial amounts of heat. Due to the high temperatures generated, high power electronic components such as the generator 114 and electric propulsion motor(s) 134 will typically be cooled (e.g., water-glycol cooled), in a lower temperature cooling loop than the ICE 112 cooling loop. In addition, airflow paths in the vehicle are designed to provide for external cooling of the electronic components. Thus cooling air may flow through the engine compartment, exchanging heat with the various engine components, and eject heat from the vehicle. Thus, two separate temperature compartments may be kept to meet the temperature requirements of different components. Cooling is a crucial consideration in hybrid drive systems.

Since the HEV drive system 100 may include multiple energy sources (i.e., engine genset 110, energy storage device 120, and drive wheel propulsion assembly 130 in regen), to freely communicate power, these energy sources may then be electrically coupled to a power bus. In this way, energy can be transferred between components of the high power hybrid drive system as needed.

An HEV may further include both AC and DC high power systems. For example, the drive system 100 may generate and run on high power AC, but may convert it to DC for storage and/or transfer between components across a DC high power bus 150. Accordingly, the current may be converted via an inverter/rectifier 116, 136 or other suitable device (hereinafter “inverters”). Inverters 116, 136 for heavy duty vehicles (i.e., having a gross weight of over 10,000 lbs) may include a special high frequency (e.g., 2-10 kHz) IGBT multiple phase water-glycol cooled inverter with a rated DC voltage of 650 VDC having a peak current of 300 A. As illustrated, HEV drive system 100 includes a first inverter 116 interspersed between the generator 114 and the DC high power bus 150, and a second inverter 136 interspersed between the generator 134 and the DC high power bus 150. The inverters 116, 136 are shown as separate devices; however their functionality can be incorporated into a single unit. High power cables will typically interface generator 114 and electric propulsion motor(s) 134 with their respective inverters 116, 136.

In addition to utilizing different types of electrical currents, not all energy sources of drive system 100 provide an identical and/or static energy profile. For example, energy storage 120, comprising a bank of ultracapacitors in series, may have an initial DC voltage of 700 VDC, however, its voltage decreases significantly as it discharges, proportionally to its static charge. Propulsion motor(s) 132 for heavy duty vehicles may require an operational voltage on the order of 650 VDC or more. Accordingly, in order to provide sufficient operating voltage when the energy storage is discharging, it may be desirable to substantially step up the voltage of the energy storage from an available voltage to an operational voltage.

One technique for efficiently increasing the voltage of the electricity available on the DC bus 150 involves using an inductor-based boost converter, DC-DC converter, or chopper (hereinafter “chopper”). See for example, J. W. McKeever, S. C. Nelson, and G. J. Su, “Boost Converters for Gas Electric and Fuel Cell Hybrid Electric Vehicles,” Oak Ridge National Laboratory, ORNL/TM-2005/60, May 27, 2005. With a high power electric drive system, such as found in metropolitan transit buses, trolley cars, refuse collection trucks, and other heavy duty vehicles, the chopper may see DC currents on the order of 300 A at 800 VDC.

In the illustrative HEV drive system 100, three-phase electric power is transferred using high power cables. The three phase electric power is a polyphase system mainly used to power motors and many other devices. In a three-phase system, three high power cables carry three alternating currents of the same frequency, but out of phase, that is they reach their instantaneous peak values at different times. Taking the current for one cable as the reference, the other two currents in the other two high power cables are delayed in time by one-third and two-thirds of one cycle of the electrical current. This delay between “phases” has the effect of giving constant power transfer over each cycle of the current, and also makes it possible to produce a rotating magnetic field in an electric motor.

Three-phase electric power has properties that make it very desirable in electric power systems. Firstly, the phase currents tend to cancel out one another, summing to zero in the case of a linear balanced load. This makes it possible to eliminate the neutral conductor on some lines because all the phase conductors carry the same current and so the high power cables can be the same size and carry a balanced load. Secondly, power transfer into a linear balanced load is constant, and this helps to reduce generator and motor vibrations. Finally, three-phase systems can produce a magnetic field that rotates in a specified direction and at a specific rate, which simplifies the design of electric motors.

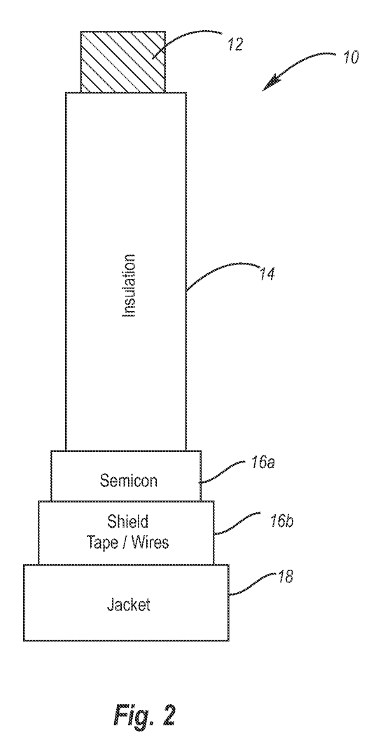

Electrical vehicles and hybrids operate with high power electricity on the order of hundreds of Amps at hundreds of Volts, and heavy gauge wire and high power cables are required to safely carry the load. An illustrative high power cable 10 is shown in FIG. 2 that consists of the conducting cable 12, an insulation cover 14, EMF shielding 16a and 16b, and an outer protective jacket 18 such as a corrugated conduit. As discussed above, oftentimes, the vehicle's generators and electric motors will operate on three-phase AC power. The high power cables may then be used to transfer three-phase current that is used to power these high voltage systems of a hybrid with each phase being conducted over one of three cables.

Hybrid vehicles may be converted from conventional drive systems. As fuel prices rise and as emissions standards become stricter, many vehicle manufacturers have embraced these hybrid propulsion systems. Oftentimes, however, rather than create an entirely new vehicle design, it is more cost effective to merely retrofit a preexisting vehicle design with a new hybrid drive system. This is an especially attractive option since electric propulsion systems are typically modular in nature and not subject to the same physical constraints as a conventional drive system. For example, in a conventional system the engine, transmission, drive shaft, and differential, must be physically connected and usually in a coaxial manner. In contrast, a hybrid system, operating on electricity, need only couple its various components via high power cabling.

Vehicle designs in general do not waste space, and free space between a conventional drive train and the vehicle chassis is typically limited. These high power cables used in retrofitting preexisting vehicle designs, which often have very limited free space, are typically of heavy gauge, are insulated, and are multiplied by the number of phases of current provided (i.e., typically three-phase). The limited free space can be easily become a design constraint by heavy duty hybrid drive system integrators because heavy duty hybrid drive system integrators have limited, if any, input into the design of the vehicle that is being adapted to use the high power cables.

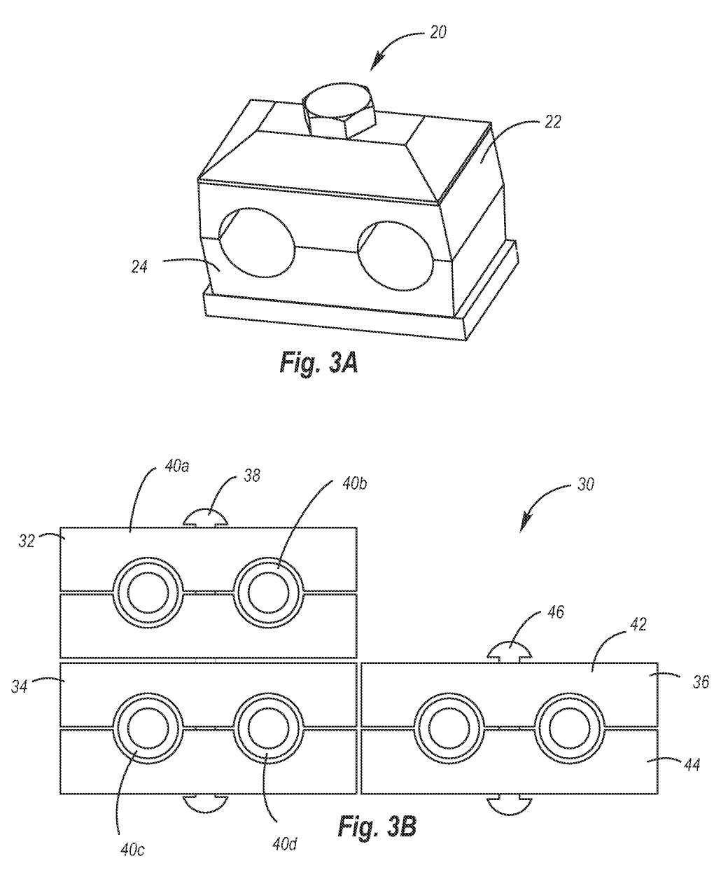

An apparatus used for routing the high power cables through an electrical vehicle includes the clamps presented in FIGS. 3A and 3B. FIG. 3A shows an isometric view of a routing clamp 20 composed of a top element 22 and a bottom element 24 that are configured to receive two power cables. The bottom of the top element 22 comprises two semicircular barrels that are each configured to interface with one of the two power cables. Additionally, the top of the bottom element 24 also comprises two semicircular barrels that are each configured to interface with one of the two power cables. Typically, the routing clamp is composed of two elements that are relatively planar and are stackable blocks.

Referring now to FIG. 3B there is shown a side view of a clamping system 30 that includes stackable clamps. The illustrative clamping system 30 includes three clamps 32, 34 and 36, in which clamp 32 is stacked on top of clamp 34. The two clamps 32 and 34 are coupled to another with a fastener 38 that holds together each element of clamps 32 and 34 and the illustrative power cables 40a, 40b, 40c, and 40d. Adjacent to the clamp 34 is clamp 36, in which the top element 42 and bottom element 44 are fixedly coupled to one another by fastener 46.

There are various benefits to the routing clamps presented in FIGS. 3A and 3B including separating the power cables for cooling purposes, to prevent chaffing, inexpensive standard parts, and positive separation preventing high voltage arching. However, there are also various limitations to these routing clamps and clamping systems. These limitations reflect the unique ancillary problems associated with heavy-duty hybrids in general, and reusing preexisting vehicle designs in particular.

One of the limitations include bulky routing clamps that result in the power cables taking up the limited free space. This is especially true when the routing clamps are stacked, see for example FIG. 3B. Moreover, system integrators' and designers' design options are reduced as they must accommodate for the bulky clamps and associated cabling. This bulkiness may also result in reduced maintainability, since technicians will have less free space to maneuver.

Another limitation is associated with the routing of the high power cables from one place to another, so that the outer protective jacket and EMF shielding is not compromised. For example, in the mobile environment, high power cables will often be further protected using a supplemental, or outer conduit, that shields the cables against high temperature, chemicals, and impacts. This added conduit results in a greater diameter, (i.e., greater displaced area) and reduced bend radius (i.e. reduced routing options). Moreover, in multi-phase AC systems, the increased size is further multiplied by the number of phases.

There is also the negative consequence to these bulky routing clamps, namely, obstructing too much space limits air flow. This may lead to stagnant air and less cooling. As discussed above, cooling is crucial in hybrid drive systems. This is because without adequate airflow heat may accumulate leading to damage or requiring additional cooling systems.

Furthermore, EMF and electronic noise are also problems that can be caused by the high power lines. Although the high power cables are shielded, experience has shown that impacts, age, and misuses can damage the cable shielding, allowing EMF and electronic noise to be transmitted to the environment. Moreover, when the clamps are stacked, the fasteners that hold the cables can even operate like antennas, adding to the problem. In fact, it is becoming more common to find restrictions on hybrid vehicles operating in public areas that are susceptible to being impacted by “electronic pollution.” Accordingly, there is a need for an efficient clamping system that manages high power cables in a hybrid/electric drive system, while mitigating the problems associated with chaffing, constricted airflow, RF noise, and the mobile environment.

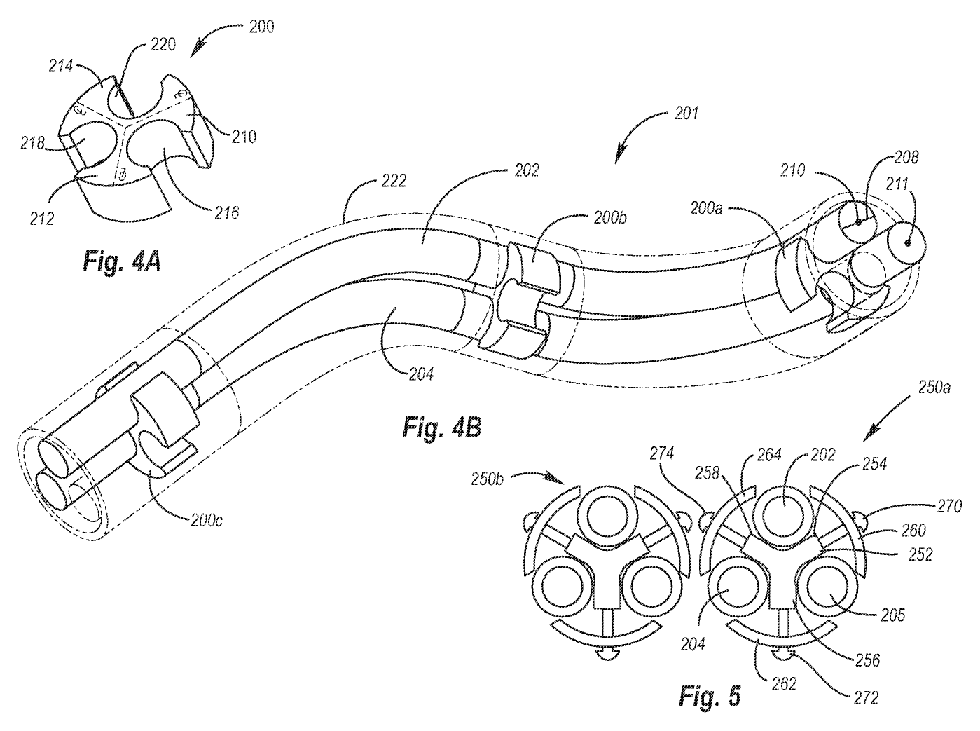

With reference generally to FIGS. 4A-7C, embodiments of the cable fastening systems and cable spacer of the present invention will be described. As indicated above, there is a need to hold or brace these high power cables in the heavy duty vehicles in a manner that is not bulky, occupies limited space, supports stacking the cables, protects the outer protective jacket and EMF shielding, supports or enables cooling in the presence of the high power cables, reduces the impact of EMF transmissions, and reduces the impact of electronic noise. Accordingly, the systems, apparatus and methods described herein provide a means for clamping and separating high voltage cables efficiently and as needed.

The cable fastening systems and cable spacers described herein may be configured to be coupled to high power cables that operate within a heavy duty vehicle such as a hybrid electric vehicle (HEV). Additionally, the cable fastening systems and cable spacer embodiments described herein are configured to hold or brace the high power cables, provide positive displacement, are not bulky, occupy limited space, support stacking the cables, protect the outer protective jacket and EMF shielding, enable cooling the high power cables, reduce the impact of EMF transmissions, and reduce the impact of electronic noise.

The method for fastening cables in a heavy-duty hybrid electric vehicle described herein may include positioning three AC vehicle propulsion cables, each having a cross section and a cross-sectional diameter, and each transmitting one phase of the three phase AC power supply, such that each of the three AC vehicle propulsion cables are positively displaced from each other while remaining within one cross-sectional diameter of each other; orienting the cross sections of the three AC vehicle propulsion cables in a triangular formation as referenced from the same plane; and, securing the three AC vehicle propulsion cables as positioned and oriented above. In doing so, a single integrated device may be used. In the alternate separable devices may be used. Furthermore, the method may result in free-floating line fastening means, an anchored fastener, and/or combination of both. In alternate embodiments, the method may include sets of propulsion cables, associated with a plurality of multi-phase generators (e.g., dual 3-phase drive motor in regen), which are coupled together through various means.

Referring to FIG. 4A there is shown an isometric view of one preferred embodiment of a first illustrative cable spacer that interfaces with a protective conduit 222 (as shown in FIG. 4B). The illustrative cable spacer 200 is configured to separate three conductive high power cables that conduct three phase propulsion power of the vehicle. Similarly, in alternate embodiments having other multi-phase systems, the high power cables may be positioned such that each of the multiple phases are coupled together. Here as illustrated, the isometric view of cable spacer 200 further shows three fixed arms 210, 212, and 214 that extend from the center of the spacer 200.

Preferably, each of the fixed arms 210, 212 and 214 has a rounded end that conforms to a circular arc. This will provide for a more secure fit and reduced opportunity for the accumulation of grime, debris, and other materials commonly present in a mobile environment. The center line for each of the fixed arms 210, 212 and 214 are disposed at approximately equal angles from one another, i.e., approximately 120°.

Additionally, the cable spacer 200 may preferably comprise three arcuate edges 216, 218 and 220 that are disposed at approximately equal angles from one another, i.e. approximately 120°. Each of the three arcuate edges 216, 218 and 220 interfaces with a corresponding high power cable. Each fixed arm 210, 212, and 214 separates two arcuate edges and each arcuate edge is configured to interface with one of the conductive high power cables. The illustrative arc for each of the arcuate edges 216, 218 and 220 is similar; and for the illustrative spacer 200, the arcuate edges may have an arc that is greater than 180°, thereby enabling the arcuate edges to pinch or crimp the corresponding power cable. Accordingly, spacer 200 may be constructed of a ductile material that would deform sufficiently to permit passage of the conductive high power cables into and out of the grip of the arcuate edges

Referring to FIG. 4B, a more detailed view of a cable fastening system 201 comprising two power cables 202 and 204 is provided (the third power cable has been removed for illustrative purposes). The illustrative power cable 202 has a cross-sectional diameter 208 and cross-sectional center 210. Similarly, power cable 204 also has a cross-sectional diameter 211 that is similar to the cross-sectional diameter 210 associated with power cable 202.

The cable fastening system 201 is illustrated using three spacers 200a, 200b, and 200c that are similar to the spacer 200 in FIG. 4A. The rounded ends of the fixed arms of the three spacers 200a, 200b, and 200c are configured to interface inside a conduit 222 that is represented by dotted lines. The conduit 222 may only include an insulating jacket, a combination of the insulating jacket and a conductive shield, or any such combination. The spacers 200a, 200b, and 200c separate the high power cables 202 and 204 from one another, and the spacers 200a, 200b and 200c separate the high power cables from the walls of conduit 222. By way of example and not of limitation, the conduit 222 may comprise a protective conduit available from the Moltec Trading Group, Ltd. As discussed above, when each cable has its own protective conduit, the multiple protective conduits for the group of power cables, and their associated routing clamps (see FIGS. 2A and 2B), greatly increase the cross-sectional area taken up by the three phase power cabling. In contrast and as illustrated here, by coupling the three power cables first, only one single protective conduit is required. Significant space saving may thus be realized.

The cable spacer 200 is configured to separate the illustrative adjacent power cables 202 and 204 so that the distance between the two adjacent power cable cross-sectional centers 210 and 211 is less than one times the cross-sectional diameter 210. Thus, when three cables are placed in the spacer 200, the spacer 200 separates the high power cables so that the corresponding cable cross-sectional centers are equidistant from one another and are oriented in a triangular formation.

As discussed above, the close placement of the cables provided for less bulkiness. In addition, by placing complementary phases of the same power source in such close proximity, systematic RF noise emanating from each line may be substantially cancelled. The configuration described herein reduces electronic noise of the high power line by using the out-of-phase noise of each cable to cancel the noise of the other nearby cables. With respect to noise, the apparatus and systems described herein provide noise cancellation by placing the cables in close proximity to one another, thereby attenuating electromagnetic forces (EMF). More particularly, the power cables operate in a different phase and are clamped in close proximity to each other in a triangular pattern reflecting the presence of three phases of AC transmissions.

In operation, three power cables are snapped into a smooth version of the cable spacer 200 and the three power cables are fed into a single protective conduit 222. According to one embodiment, a lubricant may be applied to spacer 200. Multiple spacers may be coupled to the power cables. This cable fastening system 201 results in a single, low RF noise, three phase vehicle high-power transmission line that is easy to inspect and provides for simplified replacement of individual cables. Additionally, the cross-sectional displacement of the vehicle's power lines is greatly reduced.

As discussed above, cable fastening system 201 holds the cables in close proximity, thereby reducing RF noise. However and in addition, the cable fastening system 201 also prevents the high power cables from chafing against each other as may be expected when a heavy duty vehicle is in motion. Thus, the amount of chafing on the high power cables is reduced as a function of time. This in turn reduces the statistical likelihood of a short in the vehicle's power cables, which could cause a catastrophic loss. Furthermore, vehicle maintenance is improved by preventing cable chafing so that periodic inspection of the cables based on a statistical failure rate are minimized, and the cable inspection intervals may be increased.

It shall be appreciated by those of ordinary skill in the art having the benefit of this disclosure that the number of clamps and their spacing is further dependent on the gauge and routing of the power lines. For example, with 0.50 inch cabling one cable spacer per foot may be sufficient in straight sections of the cable routing. Additionally, it is further understood that the number of spacers used may vary according the routing. For example, a short, straight line routing may require few spacers, where as a long, winding routing, having tight bend radii, may require many spacers. Independent of the number of spacers required, when assembled,

Referring to FIG. 5 there is shown another cable fastening system comprising a spacer, outer shells, and fasteners. Here the positioning/orienting means and the securing means are separable. This configuration may be used in a free-floating manner where the spacer is held in place by virtue of its attachment to the power cables. It is common for certain heavy-duty HEVs to have multiple electric propulsion motors (see e.g., dual combined motors 134). In such drive system configurations, two (or more) sets of three AC vehicle propulsion cables may be present, in which case the sets may fastened together into sets. Accordingly, there are two cable fastening systems 250a and 250b shown in FIG. 5 that are similar to each other and in some aspects to spacer 200. For example, the cable fastening system 250a includes a spacer 252 similar to the spacer 200. The similarities include spacer 252 having three fixed arms 254, 256 and 258 that extend from the center of spacer 200, wherein each fixed arm and optional arcuate edge is at approximately a 120° angle from the adjacent fixed arm or arcuate edge. However, the arcuate edges of the spacer 252 are not configured to pinch or hold the power cables 202, 204 and 205 as spacer 200.

Instead three outer shells 260, 262 and 264 are shown that secure the power cables 202, 204 and 205. Each outer shell 260, 262 and 264 comprises a center line that is disposed perpendicular to the corresponding spacer arm 254, 256 and 258, respectively. Additionally, outer shell 260 is configured to interface with power cables 202 and 205, outer shell 262 interfaces with power cables 205 and 204, and outer shell 264 interfaces with power cables 204 and 202.

Three fasteners 270, 272, and 274 are also shown that are configured to pass through an opening (not shown) along the center line of each outer shell 260, 262 and 264, respectively. The three fasteners 270, 272 and 274 are then fastened to the fixed spacer arms 254, 256 and 258. In the illustrative embodiment, the fasteners 270, 272 and 274 are threaded fasteners such as screws with domed screw heads with threads that can interface with the corresponding hollow fixed spacer arm 254, 256 and 258. However, it is understood that fastening means are well-known and one skilled in the art will recognize that certain fastening means are more appropriate to a particular application. For example, where it is expected that individual lines may be likely to be removed frequently a quick-release type fastening means may be better suited.

Additionally, there may also be a bracket (not shown) that is disposed between one of the fasteners 270, 272, 274 and the corresponding outer shells 260, 262, and 264. The bracket may then be fixedly coupled with another fastener (not shown) to the vehicle chassis wall or to a component in drive system 100 described above in FIG. 1, thereby anchoring or otherwise securing the cable fastening system to a relatively fixed point. For example, the cable fastening system 250 may be configured to be fixedly coupled to a mounting point on the inverter 116 or the generator 114 shown in FIG. 1. Thus, the cable fastening system 250 and the fastened cables do not vibrate freely, but rather may modeled as fixed to the illustrative inverter 116 and generator 114 in the illustrative heavy duty HEV. In the alternate, and with modification of the illustrated fasteners 270, 272, 274, the cable fastening system 250 may also interface with a conduit cable fastening system 201 as shown in FIG. 4B.

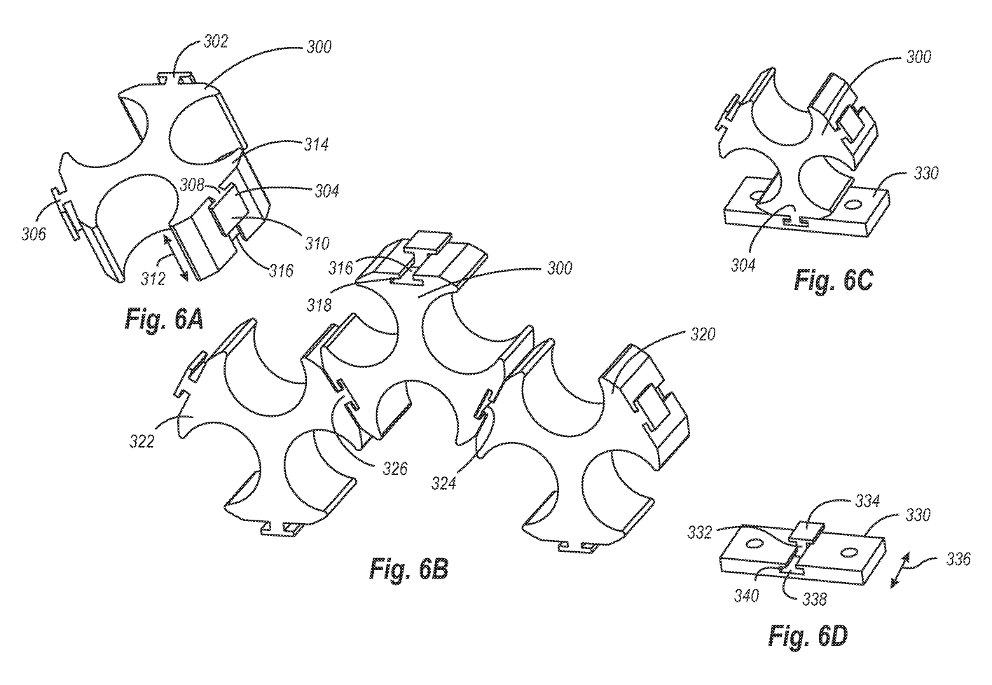

Referring to FIG. 6A there is shown an isometric view of another illustrative spacer with an exterior interlocking mechanism. The spacer 300 is similar in shape to the spacer 200 in FIG. 4A, except that spacer 300 has three interlocking mechanisms 302, 304 and 306. A more detailed view of the interlocking mechanism 304 shows a T-shaped stem and plate, in which a stem 308 extends from the fixed arm to a square plate 310. The T-shaped stem 308 and square plate 310 are illustrated as extending only half way along the width 312 of the fixed arm 314. Adjacent to the T-shaped stem and plate is a plate channel (not shown) and a stem cavity 316. Thus, adjacent to each interlocking mechanism 302, 304 and 306 there is a plate channel and stem cavity that interface with the interlocking mechanism from another interlocking spacer. This exemplary illustration is provided as an example of securing the three AC vehicle propulsion cables to the heavy-duty hybrid electric vehicle or a component thereof or alternately coupling the three AC vehicle propulsion cables to another set of similarly positioned, oriented, and secured three AC vehicle propulsion cables.

FIG. 6B shows the spacer of FIG. 6A interfacing with two similar spacers, associated with separate sets of propulsion power lines, using the exterior interlocking mechanism. In this instance, the spacer 300 is twisted 1800 about the y-axis and the stem cavity 316 and plate channel 318 are visible. The interlocking spacers 320 and 322 and their corresponding T-shaped stem and plate 324 and 326, respectively, are both slidably coupled to the female ends of spacer 300.

FIG. 6C shows an isometric view of the spacer 300 of FIG. 6A anchored to an anchoring plate 330. A more detailed view of the anchoring plate 330 is shown without the spacer in FIG. 6D. The anchoring plate 330 also includes a stem 332 that extends from the fixed arm to a square plate 334. The stem 332 and square plate 334 only define a portion of the width 336 of the anchoring plate 330. The illustrative width 336 of the anchoring plate 330 is approximately one (1) power cable diameter. Adjacent to the T-shaped stem 332 and plate 334 is a plate channel 338 and a stem cavity 340.

In FIG. 6C, the interlocking mechanism 304 associated with spacer 300 interfaces with the anchoring plate 330. The male portion of the interlocking mechanism 304 is defined by the T-shaped stem 308 and square plate 310 and is slidably coupled to the female portion of the anchoring plate 330, namely, the plate channel 338 and the stem cavity 340. On the opposing side of the interlocking mechanism 304 (not shown), the female portion of spacer 300 interfaces with the T-shaped stem 332 and plate 334 corresponding to the anchor plate 330.

Again, numerous variations are contemplated for anchoring or otherwise securing the cable fastening system to a relatively fixed point, as will be readily apparent depending on the application and available attach surfaces. For example the illustrative cable fastening systems described in FIG. 3A, FIG. 6D and FIG. 6E can be used as an anchor end for the illustrative power cables. Additionally, the illustrative securing mechanisms in FIG. 3A, FIG. 6D and FIG. 6E are not limited to a particular fastener embodiment so the fastening means may be removable, fixed, or any combination thereof.

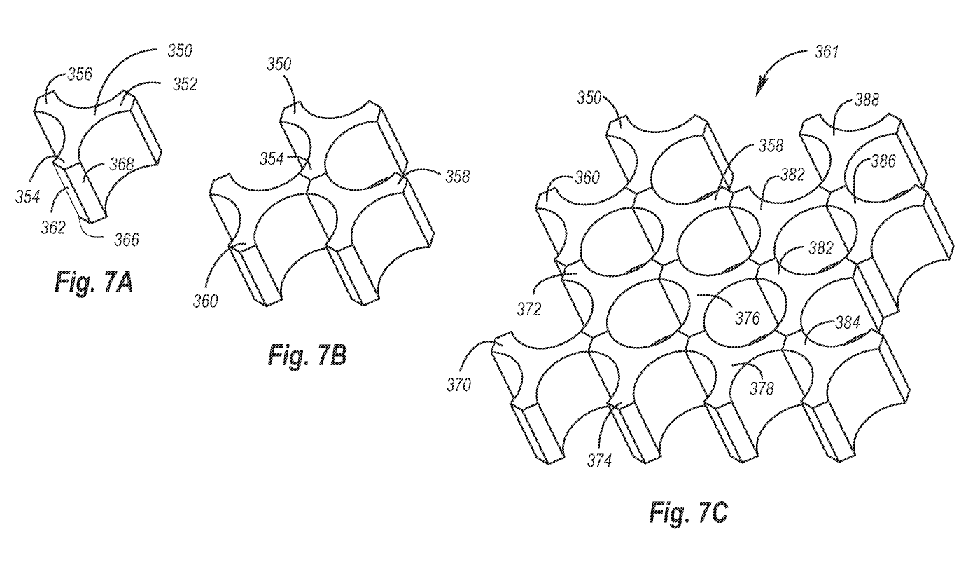

Referring to FIG. 7A there is shown yet another spacer that can be used to form a lattice structure. The spacer 350 has three fixed arms 352, 354 and 356, in which each fixed arm has a wedge shaped end that is configured to interface with the wedge shaped ends of similar spacers. This provides for a universal positioner that is both compact and expandable. For example, in FIG. 7B there is shown the wedge shaped end 354 of spacer 350 interfacing with spacers 358 and 360. For simplicity, the wedge shaped ends on each of the spacers 350, 358 and 360 are shown as smooth longitudinal faces 362 and 264 that share a common edge 366. However, the smooth longitudinal faces may include channels and stems and plates as described above in FIG. 6A through FIG. 6C.

Referring to FIG. 7C there is shown a lattice structure 361 formed from a plurality of spacers. The lattice structure includes the spacers 350, 358 and 360 and an additional group of 10 spacers, namely, spacers 370, 372, 374, 376, 378, 380, 382, 384, 386 and 388. In total there are 13 spacers shown in FIG. 7C forming a lattice structure that is stackable and mimics a honeycomb appearance.

The applications for the lattice structure 361 include, but are not limited to, applications that have multiple sets of three-phase power lines such as dual drive motors, drive motors, engine genset mounted in close proximity, such as when using the same inverter. By way of example and not of limitation, the lattice structure 361 may be used in combination with one of the cable fastening systems described above that include securing mechanisms such as the interlocking mechanisms described in FIG. 6A through 6D. Thus, this embodiment may be used where multiple sets of power lines are in close proximity and/or were the application may include an expandable system. In this alternate embodiment, each set of high power cables may be positioned with their individual phases secured adjacent to one another.

It is to be understood that the detailed description of illustrative embodiments are provided for illustrative purposes. The scope of the claims is not limited to these specific embodiments or examples. As described herein, the cable fastening systems and cable spacer route and separate high power cables, are stackable, take up limited free space, enable cooling, prevent high voltage arching, protect the outer jacket of each power cable, reduce EMF, and reduce electronic noise. Various structural limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A cable fastening system for a heavy-duty hybrid electric vehicle having a three phase AC power supply, the cable fastening system comprising:
three AC vehicle propulsion cables, each having a cross section and a cross-sectional diameter, and each transmitting one phase of the three phase AC power supply;
a positioning mechanism configured to positively displace each of the three AC vehicle propulsion cables from each other, but such that the three AC vehicle propulsion cables remain within one cross-sectional diameter of each other, the positioning mechanism further configured to orient the cross sections of the three AC vehicle propulsion cables in a triangular formation as referenced from the same plane; and,
a first securing mechanism configured to retain the three AC vehicle propulsion cables to the positioning mechanism.

2. The cable fastening system of claim 1, wherein the first securing mechanism includes a release mechanism providing for the securing mechanism to open, allowing the three-phase AC high-power cables to be removed from the positioning mechanism.

3. The cable fastening system of claim 1, wherein the positioning mechanism comprises an insert located between the three-phase AC high-power cables; and,
wherein the first securing mechanism is configured to be added to the insert after the three-phase AC high-power cables are positioned.

4. The cable fastening system of claim 3, wherein the first securing mechanism comprises a tubular structure that encloses at least a portion of the three AC vehicle propulsion cables and the insert.

5. The cable fastening system of claim 4, wherein the tubular structure comprises a protective tubular structure; and,
wherein the first positioning mechanism further comprises a plurality of inserts located between the three-phase AC high-power cables and distributed within the protective structure.

6. The cable fastening system of claim 1, wherein the positioning mechanism comprises three arms radially coupled at a central axis, and that are disposed at approximately equal angles from one another, as referenced from a plane perpendicular to the central axis.

7. The cable fastening system of claim 6, wherein the first securing mechanism comprises at least one outer shell, and wherein the at least one outer shell is fastened to at least one of the three arms.

8. The cable fastening system of claim 1, wherein the positioning mechanism and first securing mechanism are integrated into a single integrated device.

9. The cable fastening system of claim, wherein the integrated positioning mechanism and first securing mechanism comprise three arcuate edges having an arc measuring greater than 180°, each of the three arcuate edges disposed at approximately equal angles from one another and configured to interface with and crimp one of the three AC vehicle propulsion cables; and,
wherein the integrated positioning mechanism and first securing mechanism further comprise three arms radially coupled at a central axis, each of the three arms disposed at approximately equal angles from one another, as referenced from a plane perpendicular to the central axis, and wherein each of the three arms separates two of the three arcuate edges.

10. The cable fastening system of claim 1, further comprising a second securing mechanism configured to secure the cable fastening system to the heavy-duty hybrid electric vehicle or a component thereof.

11. The cable fastening system of claim 10, wherein the positioning mechanism, first securing mechanism, and the second securing mechanism are integrated into a single integrated device.

12. The cable fastening system of claim 1, further comprising a third securing mechanism configured to secure the cable fastening system to another of said cable fastening system.

13. The cable fastening system of claim 12, wherein the positioning mechanism, first securing mechanism, the second securing mechanism, and the third securing mechanism are integrated into a single integrated device.

14. A method for fastening cables in a heavy-duty hybrid electric vehicle having a three phase AC power supply, the method comprising:
positioning three AC vehicle propulsion cables, each having a cross section and a cross-sectional diameter, and each transmitting one phase of the three phase AC power supply, such that each of the three AC vehicle propulsion cables are positively displaced from each other while remaining within one cross-sectional diameter of each other;
orienting the cross sections of the three AC vehicle propulsion cables in a triangular formation as referenced from the same plane; and,
securing the three AC vehicle propulsion cables as positioned and oriented above.

15. The method of claim 14, wherein the securing the three AC vehicle propulsion cables comprises inserting the three AC vehicle propulsion cables at least partially in a tubular structure.

16. The method of claim 14, wherein the positioning three AC vehicle propulsion cables and the orienting the cross sections of the three AC vehicle propulsion cables comprises placing at least one insert between the three AC vehicle propulsion cables.

17. The method of claim 16, wherein the securing the three AC vehicle propulsion cables comprises inserting the at least one insert and the three AC vehicle propulsion cables at least partially in a tubular structure.

18. The method of claim 14, further comprising securing the three AC vehicle propulsion cables to the heavy-duty hybrid electric vehicle or a component thereof.

19. The method of claim 18, further comprising securing the three AC vehicle propulsion cables to the heavy-duty hybrid electric vehicle or a component thereof such that the positioning, the orienting, and the securing the three AC vehicle propulsion cables as positioned and oriented is performed by a single integrated device.

20. The method of claim 14, further comprising coupling the three AC vehicle propulsion cables to another set of similarly positioned, oriented, and secured three AC vehicle propulsion cables such that the positioning, the orienting, and the securing of each set of three AC vehicle propulsion cables and their coupling is performed by a single integrated device.
